(19) United States
(12) Patent Application Publication
(10) Pub. No.: US 2011/0014461 A1
(43) Pub. Date: Jan. 20, 2011

(54) HOUSING AND METHOD FOR MAKING THE SAME

(75) Inventors: HONG-BO LI, Shenzhen City (CN); YAN-MIN WANG, Shenzhen City (CN); GANG HUANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/604,911

(22) Filed: Oct. 23, 2009

(30) Foreign Application Priority Data
Jul. 17, 2009 (CN) 200910304494.1

(51) Int. Cl. B32B 5/14; B05D 1/36

(52) U.S. Cl. 428/341; 427/402

(57) ABSTRACT

A method for making a housing, comprising the steps of: providing a substrate, the substrate having a working surface; forming a first colored paint layer on the whole working surface; and forming a second colored paint layer on a section of the first colored paint layer using a plurality of spray guns, the second colored paint layer having a first section and second section, the spray guns corresponding the second section having a atomizing pressure increasing with the increase of its corresponding section from the first section, and a flow-rate decreasing according to the increase of distance of its corresponding section from the first section. A housing made by the present method is provided.

### BACKGROUND

1. Technical Field

The present disclosure generally relates to a housing with a multicolor appearance and a method for making the same.

2. Description of Related Art

Electronic devices having a decorative housing are attractive. In-Mold Labeling (IML) is a typical method for producing decorative housings. Specifically, a preformed plastic film with a decorative layer of ink can be in-mold labeled with a plastic substrate within a mold. However, the decorative layer made of ink usually presents an appearance of only one simple color and it can be difficult to present a multicolor appearance.

Therefore, there is room for improvement within the art.

### BRIEF DESCRIPTION OF THE DRAWINGS

Many aspects of the housing and method for making the housing can be better understood with reference to the following drawings. The components in the drawings are not necessarily to scale, the emphasis instead being placed upon clearly illustrating the principles of the present housing and method for making the same.

FIG. 1 is a cross-section view of an exemplary embodiment of the present housing.

FIG. 2 is a block diagram of an exemplary process for making the present housing.

FIG. 3 is a schematic drawing of forming a second colored paint layer of an exemplary process for making the housing.

### DETAILED DESCRIPTION OF THE EXEMPLARY EMBODIMENT

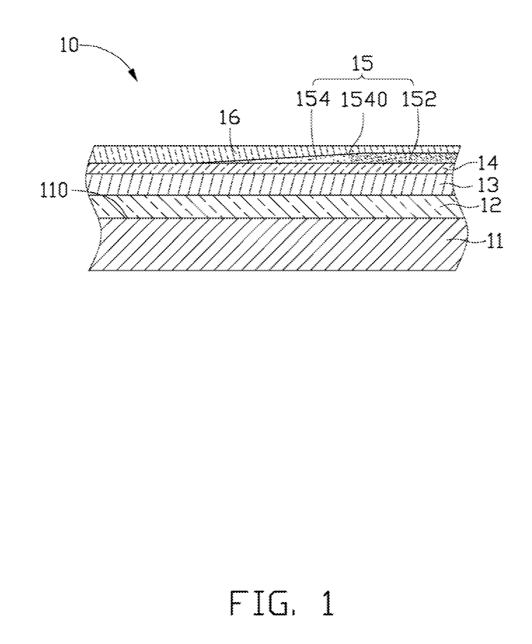

FIG. 1 shows an exemplary housing 10 for an electronic device such as a mobile phone. The housing 10 includes a substrate 11, a base paint layer 12, a vacuum coated layer 13, a first colored paint layer 14, a second colored paint layer 15, and a top paint layer 16.

The substrate 11 may be molded by a plastic e.g., polymethyl methacrylate (PMMA), polyethylene (PE), acrylonitrile-butadiene-styrene (ABS), or polycarbonate (PC). Alternatively, the substrate 11 may be made of a metal. The substrate 11 has a working surface 110.

The base paint layer 12 is formed on the working surface 110. The base paint layer 12 may be made of an ultraviolet curable paint and can strengthen the bonding of the vacuum coated layer 13 and the substrate 11.

The vacuum coated layer 13 is formed on the base paint layer 12 and may have a metallic appearance. When the housing 10 is used for an electronic device with telecommunication function, the vacuum coated layer 13 can be nonconductive to have no effect on the transmission of radio frequency signals (RF).

The first colored paint layer 14 is formed on the vacuum coated layer 13. The first colored paint layer 14 has a first color and a degree of transparency. The first colored paint layer 14 covers the whole vacuum coated layer 13. The first colored paint layer 14 may be made of an ultraviolet curable paint.

The second colored paint layer 15 is formed on a portion of the first colored paint 14. The second colored paint layer 15 has a second color different from the first color. The second colored paint layer 15 also has a degree of transparency. The second colored paint layer 15 has a first section 152 and a second section 154. The first section 152 has a thick distribution density of a second colored paint. The first section 152 covers a part of the first colored paint layer 14. The second section 154 has a thin distribution density of the second colored paint. The density of the second colored paint of the second section 154 decreases gradually away from one end 1540 of the second section 154. The end 1540 is close to the first section 152. The second colored paint layer 15 may be made of an ultraviolet curable paint.

The top paint layer 16 is coated on the second colored paint layer 15 and the portions of the first colored paint layer 14 exposed from the second colored paint layer 15. The top paint layer 16 is transparent and may be made of a paint having a soft tactility.

It should be understood, the first colored paint layer 14 may cover a section of the vacuum coated layer 13. Accordingly, the second colored paint layer 15 may be formed on remainder of the vacuum coated layer 13 (not covered with the first colored paint layer 14) and partially overlap the first colored paint layer 14.

It should be understood, the base paint layer 12 and the vacuum coated layer 13 can be omitted, accordingly, the first colored paint layer 14 being directly formed on the working surface 110 of the substrate 11.

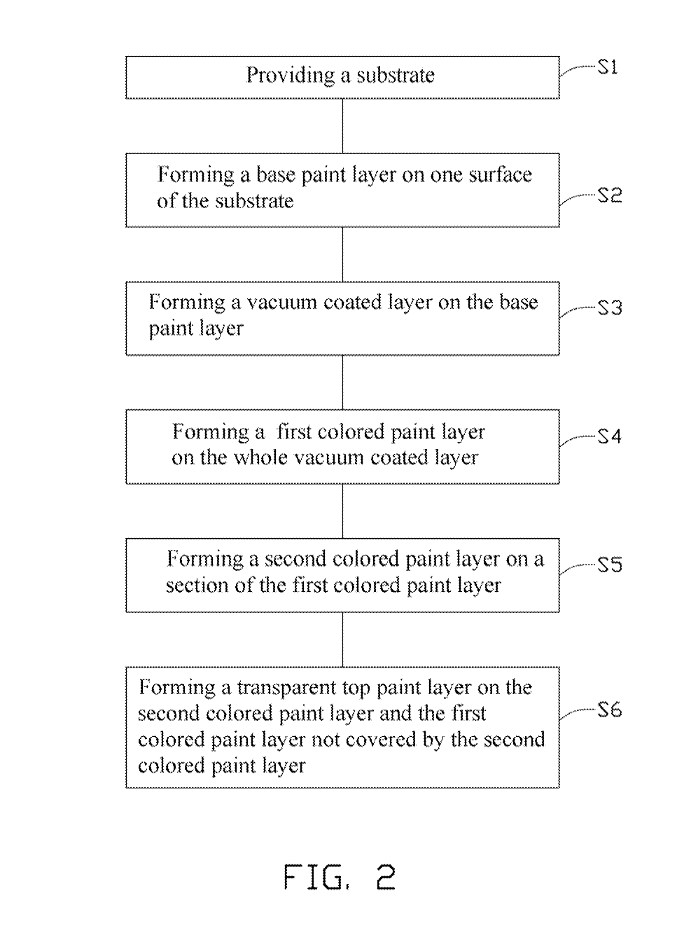

FIG. 2 shows an exemplary method for making the housing 10, which may include the following steps.

In a step S1, the plastic substrate 11 is provided. The substrate 11 has the working surface 110.

In a step S2, the base paint layer 12 is formed (e.g., painted or brushed) on the working surface 110.

In a step S3, the vacuum coated layer 13 is formed on the base paint layer 12 for example, by using a vacuum evaporating method or a vacuum sputtering method.

In a step S4, the first colored paint layer 14 is formed (e.g., painted) on the whole vacuum coated layer 13.

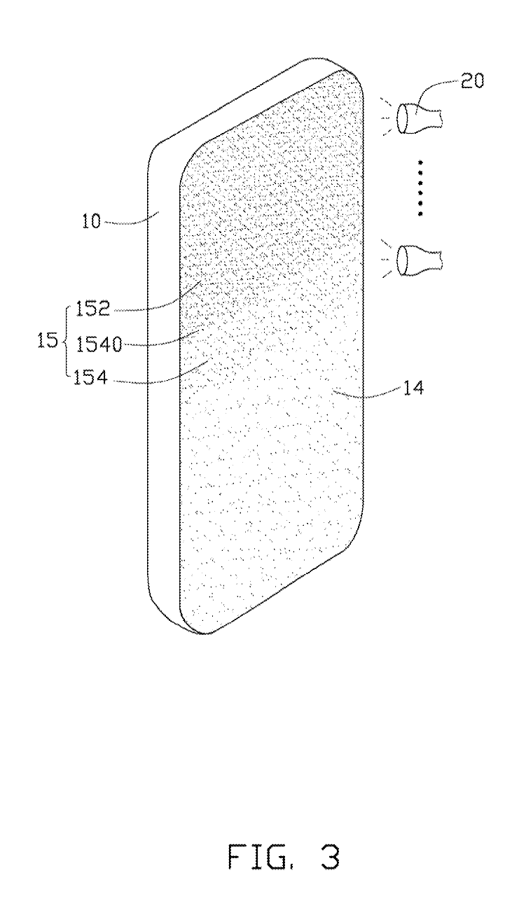

In a step S5, a second colored paint layer 15 is painted on a section of the first colored paint 14. FIG. 3 shows the process of forming the second colored paint layer 15. A plurality of spray guns 20 (e.g., three or four guns) are used to paint the second colored paint layer 15. Each of the spray guns 20 is fixed in a proper position facing the substrate 11. The atomizing pressure of the spray guns 20 corresponding to the second section 154 increases according to the increase in distance from the first section 152. As stronger of the atomizing pressure is, the smaller the size of the sprayed paint drops are. The flow-rate of the spray guns decreases according to the increase in distance away from the first section 152. As the lower of the flow-rate is, the lower density of the sprayed paint is.

In a step S6, the second colored paint layer 15 and the portions of the first colored paint layer 14 that are not covered with the second colored paint layer 15 are coated with a top paint layer 16.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing, comprising:
a substrate, the substrate having a working surface;
a first colored paint layer formed on the whole working surface; and
a second colored paint layer formed on a portion of the first colored paint layer, the second colored paint layer having a first section and a second section, the distribution density of the second colored paint of the second section gradually decreasing in a direction away from one end of the second section close to the first section.

2. The housing as claimed in claim 1, wherein the substrate is made of plastic or metal.

3. The housing as claimed in claim 1, wherein the first colored paint layer and the second colored paint layer are different in color.

4. The housing as claimed in claim 1, wherein the housing further comprise a base paint layer directly formed on the working surface of the substrate.

5. The housing as claimed in claim 4, wherein the housing further comprising a vacuum coated layer directly formed on the base paint layer, the first colored paint layer being directly formed on the vacuum coated layer.

6. The housing as claimed in claim 5, wherein the vacuum coated layer has a metallic appearance and is nonconductive.

7. The housing as claimed in claim 6, wherein the first colored paint layer and the second colored paint layer have a degree of transparency.

8. The housing as claimed in claim 1, wherein the housing further comprising a transparent top paint layer coated on the second colored paint layer and the portions of the first colored paint layer exposed from the second colored paint layer.

9. The housing as claimed in claim 8, wherein the top paint layer is made of a paint having a soft tactility.

10. A housing, comprising:
a substrate, the substrate having a working surface;
a first colored paint layer formed on a section of the working surface; and
a second colored paint layer formed on remainder of the working surface not covered with the first colored paint layer and partially overlapping the first colored paint layer, the second colored paint layer having a first section and a second section, the distribution density of the second colored paint of the second section gradually decreasing in a direction away from one end of the second section close to the first section.

11. The housing as claimed in claim 10, wherein the first colored paint layer and the second colored paint layer are different in color.

12. A method for making a housing, comprising the steps of:
providing a substrate, the substrate having a working surface;
forming a first colored paint layer on the whole working surface; and
forming a second colored paint layer on a portion of the first colored paint layer using a plurality of spray guns, the second colored paint layer having a first section and second section, the spray guns corresponding the second section having an atomizing pressure increasing with the increase of its corresponding section from the first section, and a flow-rate decreasing according to the increase of distance of its corresponding section from the first section.

13. The method as claimed in claim 12, wherein the substrate is made of plastic or metal.

14. The method as claimed in claim 12, wherein the first colored paint layer and the second colored paint layer are different in color.

15. The method as claimed in claim 12, wherein the method further comprising forming a base paint layer on the working surface of the substrate.

16. The method as claimed in claim 15, wherein the method further comprising forming a vacuum coated layer on the base paint layer, the first colored paint layer being directly formed on the vacuum coated layer.

17. The method as claimed in claim 16, wherein the vacuum coated layer has a metallic appearance and is nonconductive.

18. The method as claimed in claim 17, wherein the first colored paint layer and the second colored paint layer have a degree of transparency.

19. The method as claimed in claim 12, wherein the housing further comprising a transparent top paint layer coated on the second colored paint layer and the portions of the first colored paint layer exposed from the second colored paint layer.

20. The method as claimed in claim 19, wherein the top paint layer is made of a paint having a soft tactility.
